(19) United States
(12) Patent Application Publication
(10) Pub. No.: US 2015/0257361 A1
(43) Pub. Date: Sep. 17, 2015

(54) STATIC ELECTRICITY PET HAIR REMOVER

(71) Applicant: Hugh C. MURPHY, Kerrville, TX (US)

(72) Inventor: Hugh C. MURPHY, Kerrville, TX (US)

(21) Appl. No.: 14/645,806

(22) Filed: Mar. 12, 2015

Related U.S. Application Data
(60) Provisional application No. 61/967,170, filed on Mar. 12, 2014.
(60) Provisional application No. 61/967,688, filed on Mar. 24, 2014.

(51) Int. Cl. A01K 13/00; A01K 29/00

(52) U.S. Cl. CPC A01K 13/004; A01K 13/00; A01K 29/00

(57) ABSTRACT

A pet grooming device for the removal of shedding and/or loose using static electricity is provided. One or more posts are attached to a base at various adjustable positions. Dense brushes are disposed over the one or more posts. The brushes are made of a material having a tendency to attract large numbers of electrons and hold a negative static charge. As a pet rubs itself against the posts, the pet's hair becomes positively charged. The hair is attracted to the negatively charged brush and adheres to the brush. In some embodiments, the pet may be attracted to the brushes using treats, toys, and/or catnip.

### CROSS-REFERENCE TO RELATED APPLICATIONS

The present application claims the benefit of U.S. Provisional Patent Application No. 61/967,170, filed on Mar. 12, 2014, and U.S. Provisional Patent Application No. 61/967,688, filed on Mar. 24, 2014, the contents of which are herein incorporated by reference in their entireties.

### BACKGROUND

The instant disclosure relates to a pet grooming system for collecting loose hair via static electricity. More specifically, the system provides one or more brushing devices to create static charges that collect loose pet hair.

Household pets shed loose hair and dander, which may cause many problems. These problems may include an increased risk of allergic reactions, chronic hair buildup on furniture, clothing, and other household objects, and a heightened risk of hair accumulation in a pet's throat. Therefore, removal of this loose pet hair is a desired result. Existing methods of removing loose pet hair include brushing methods, suction methods (e.g. vacuum cleaners), and adhesive methods (e.g., lint rollers). However, these are all active removal methods that require both time and effort to be expended by the owner. Further, these methods must be performed repeatedly as additional pet hair accumulates. Therefore, a need exists for a passive removal system that will effectively collect loose hair.

### SUMMARY

Static electricity is an imbalance of electric charges at rest. The charge may remain until it is able to move away by means of an electric current or electrical discharge. Static electricity may be generated by an unbalance of the molecular construction of relatively nonconductive insulators. One way static electricity may build up is through the tribolelectric effect. The triboelectric effect (also known as triboelectric charging) is a type of contact electrification in which certain materials may become electrically charged after they come into frictive contact with a different material. The polarity and strength of the charges produced may differ according to the materials, surface roughness, temperature, strain, and other properties. The triboelectric effect may induce certain materials to “cling” to each other due to an attraction between built up positive and negative charges in those materials.

According to one embodiment, a pet hair collection apparatus includes a base and one or more brushing elements coupled to the base, the brushing elements comprising a material that collects a negative electrostatic charge, wherein one or more pet hairs are collected on the one or more brushing elements based on the negative electrostatic charge. In some embodiments, the apparatus further comprises one or more support posts coupled to the base, wherein the one or more brushing elements are coupled to the support posts. In some embodiments, the apparatus further comprises one or more arms fastened to the one or more brushing elements. In some embodiments, the one or more arms connect one brushing element to another brushing element. In some embodiments, the one or more arms are connected to a single brushing element and disposed to rotate around an axis of the brushing element.

In some embodiments, the apparatus further comprises one or more pet attraction elements. In some embodiments, the one or more pet attraction elements are attached to the one or more arms. In some embodiments, the one or more pet attraction elements are disposed at the base. In some embodiments, the apparatus further comprises an electrostatic element including a plurality of conductive plates; and a dielectric layer disposed between the plurality of conductive plates. In some embodiments, the electrostatic element is coupled to the one or more brushing elements and provides an electrostatic charge to the one or more brushing elements.

According to another embodiment, a method of removing pet hair includes creating a negative electrostatic charge on one or more stationary brushing elements; creating a positive electrostatic charge on one or more pet hairs; and collecting the one or more pet hairs on the one or more brushing elements. In some embodiments, the negative electrostatic charge and the positive electrostatic charge are created via friction between the one or more brushing elements and the one or more pet hairs. In some embodiments, the negative electrostatic charge and the positive electrostatic charge are created via an electrostatic device coupled to the one or more brushing elements.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a diagram illustrating a pet hair collection system according to a first embodiment of the disclosure.

FIGS. 2A and 2B are diagrams illustrating a pet hair collection system according to a second embodiment of the disclosure.

FIG. 3 is a diagram illustrating a pet hair collection system according to a third embodiment of the disclosure.

FIG. 4A is a diagram illustrating an expanded view of the brush and corresponding attachments according to one embodiment of the disclosure.

FIG. 4B is a diagram illustrating an exemplary electrostatic element according to one embodiment of the disclosure.

### DETAILED DESCRIPTION

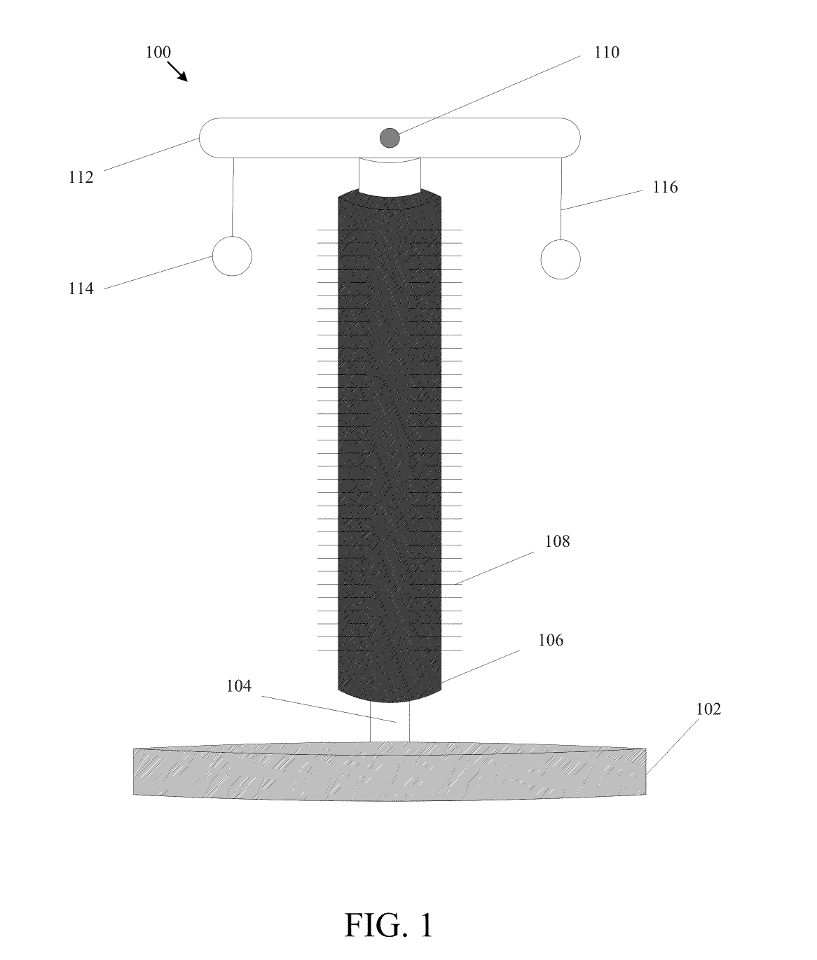

FIG. 1 is a diagram illustrating a pet hair collection system 100 according to a first embodiment of the disclosure. Pet hair collection system 100 may use the triboelectric effect to collect unwanted pet hair. System 100 may comprise a base 102, a support post 104, a brush attachment 106, and bristles 108. Some embodiments may also comprise fastener 110, arm 112, one or more pet attraction devices 114, and pet attraction device connectors 116.

Base 102, support post 104, and brush attachment may be proportioned in relation to one another in such a way as to provide stability for system 100. Base 102 may be a variety of shapes and may be comprised of a variety of possible materials, including, for example, wood, plastic, or vinyl. Base 102 may be solid or hollow and may be weighted to provide additional stability. Base 102 may be a comprised of a single piece or a plurality of pieces. Base 102 may be disposed directly on a floor or may be disposed on top of legs or pads that contact a floor. In some embodiments, base 102 may have a friction-providing layer disposed on its top surface. This friction-providing layer may assist a pet's gripping ability while walking on base 102 as well as providing stimuli against which a pet may scratch its claws. The friction-providing layer may be comprised of a material that has a high friction coefficient, such as carpet, rubber, or the like.

Support post 104 may attach to base 102 vertically via a variety of means. In some embodiments, support post 104 may be securely attached to base 102 using screws, nails, bolts, or other attachment means. In other embodiments, support post 104 may be disposed in an adjustable channel disposed in base 102. In such an embodiment, support post 104 may be secured to base 102 via a system of adjustable screws, bolts, washers, and various other attachment means. Support post 104 may be solid or hollow and may be comprised of a conductive material. In some embodiments, a plurality of support posts 104 may be provided on base 102.

Brush attachment 106 may comprise brush bristles 108 attached to a hollow core. Brush bristles 108 may comprise a material that is prone to collect electrons and maintain a negative static charge. Exemplary materials may include rubber, plastic, vinyl, polyurethane, and other various polymers. The stiffness of brush bristles 108 may vary. Preferably, brush bristles 108 have a stiffness hard enough to provide a scratching surface for a pet and dislodge loose hair while having a stiffness soft enough to provide comfort for the pet and allow some give as the pet is rubbing against bristles 108. Bristles 108 may be disposed in a variety of densities. Preferably, bristles 108 may be disposed in a density adequate to provide an even and uniform surface for the pet to contact. The pet rubs against bristles 108, static charge may be created as electrons migrate from the pet's hair to the electron-collecting material of bristles 108. Due to the static charge buildup, the pet's loose hair may cling to bristles 108, providing an effective way to remove loose hair from the pet. When the pet leaves, the hair may remain clinging to bristles 108.

Bristles 108 may be attached to a hollow core that runs vertically down the center of brush attachment 106. The core may be comprised of a conductive material and may securely attach the base of bristles 108 to brush attachment 106. Support post 104 may fit inside the hollow core of brush attachment 106 and may secure brush attachment 106 to base 102. The height of brush attachment 106 may be adjusted vertically along support post 104.

Brush attachment 106 may be fastened to the top of support post 104 via fastener 110. Preferably, fastener 110 comprises an adjustable fastening means such as a screw or bolt that allows for easy assembly and disassembly of brush attachment 106 from support frame 104. This may allow for easy removal of brush attachment 106. A user may remove brush attachment 106 for cleaning and removal of attached pet hair. In some embodiments, arm 112 may be attached to the top of brush attachment 106 via fastener 110. Arm may be stationary or may be disposed to rotate around fastener 110 as an axis. In some embodiments, one or more pet attraction devices 114 may be attached to arm 112 via one or more pet attraction device connectors 116. Pet attraction devices 114 may be devices that are attractive to the pet and may stimulate the pet to come into contact with bristles 108. For example, pet attraction devices 114 may be toys and/or objects containing treats or catnip.

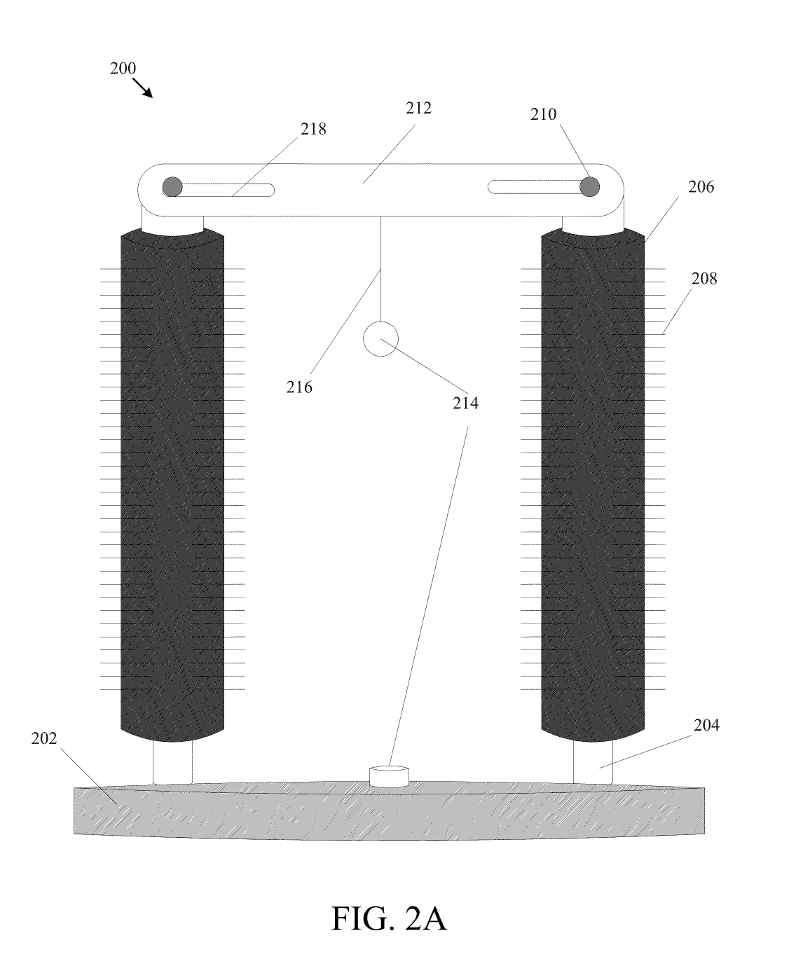

FIGS. 2A and 2B are diagrams illustrating a pet hair collection system according to a second embodiment of the disclosure. System 200 may comprise base 202, a plurality of support posts 204, and a plurality of brush attachments 206 comprising bristles 208. System 200 may also comprise one or more fasteners 210, arm 212, one or more pet attraction devices 214, and one or more pet attraction device connectors 216. These elements may have similar properties to those described in FIG. 1. In this embodiment, support posts 204 may be horizontally adjustable within base 202 to adjust the width between support posts 204. This may allow a user to adjust system 200 to accommodate different pet sizes. Arm 212 may be connected between support posts 204 and fastened to the top of support posts 204 via fasteners 210. Grooves 218 may be disposed within arm 212 to accommodate the horizontal adjustment of support posts 204. In some embodiments, a pet attraction device 214 may be disposed on or within base 202. Pet attraction device 214 may contain treats or catnip to attract the pet to system 200 and retain the pet's attention to allow for maximum loose hair collection.

As shown in FIG. 2B, in some embodiments, a horizontal brush attachment 220 may be disposed horizontally between support posts 204. Arm 212 may be disposed horizontally through a center core of horizontal brush attachment 220 and may contain grooves 218 allowing for the horizontal adjustment of support posts 204. Arm 212 may be fasted to the top of support posts 204 via fasteners 210. In some embodiments, horizontal brush attachment 220 may be stationarily affixed to arm 212. In other embodiments, horizontal brush attachment 220 may be disposed to spin or rotate about a horizontal axis provided by arm 212. In some embodiments, brush attachments 206 and horizontal brush attachment 220 may be comprise a single brush attachment disposed on a single continuous support post 204. In this embodiments, each end of support post 204 may be attached to base 202.

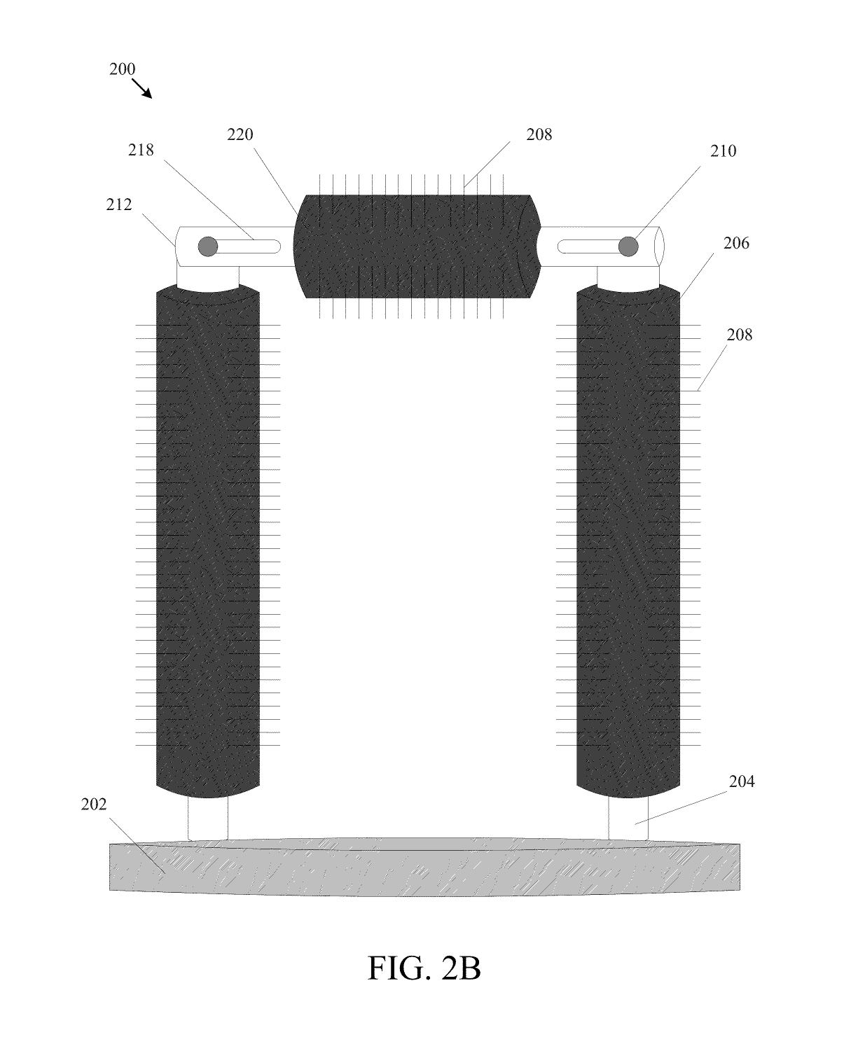

FIG. 3 is a diagram illustrating a pet hair collection system according to a third embodiment of the disclosure. System 300 may function similarly to systems 100 and 200 shown in FIGS. 1 and 2, respectively. In this embodiment, three support posts 306 are adjustably attached to base 302 through grooves 304 disposed in base 302. Support posts 306 may be adjusted horizontally by moving support posts 306 within grooves 304. Support posts 306 may attach to base 302 via fixing means. The fixing means may be loosened to allow support posts 306 to move within grooves 304 and then tightened once support post 306 is in a desired position. In some embodiments, grooves 304 may have rollers, slides, or other suitable means for moving support posts 306 within grooves 304. In some embodiments, support posts 306 may be adjusted using ratchet or friction locking devices disposed within grooves 304. System 300 may optionally have an arm disposed between support posts 306 similar to arm 212 shown in system 200 of FIG. 2. In some embodiments, pet attraction device 308 may be disposed on or within base 302 as described with reference to FIG. 2. Systems 100, 200, and 300 may be placed at various placed within a user's residence. For example, systems 100, 200, or 300 may be located near a pet door to collect loose pet hair as the pet passes through the door. In one exemplary embodiment, the pet is forced to pass between two or more brush arrangements at is moves through the door. This may increase the effectiveness of the system by ensuring that the pet contacts the brush arrangements to remove loose hair.

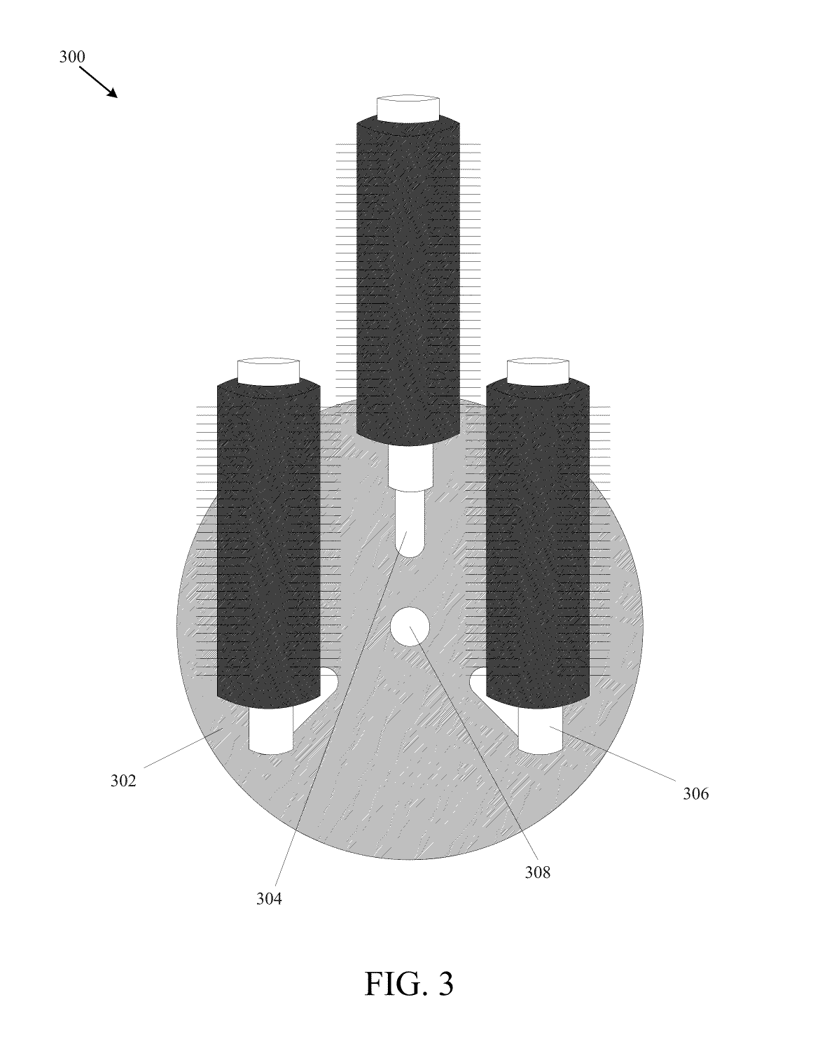

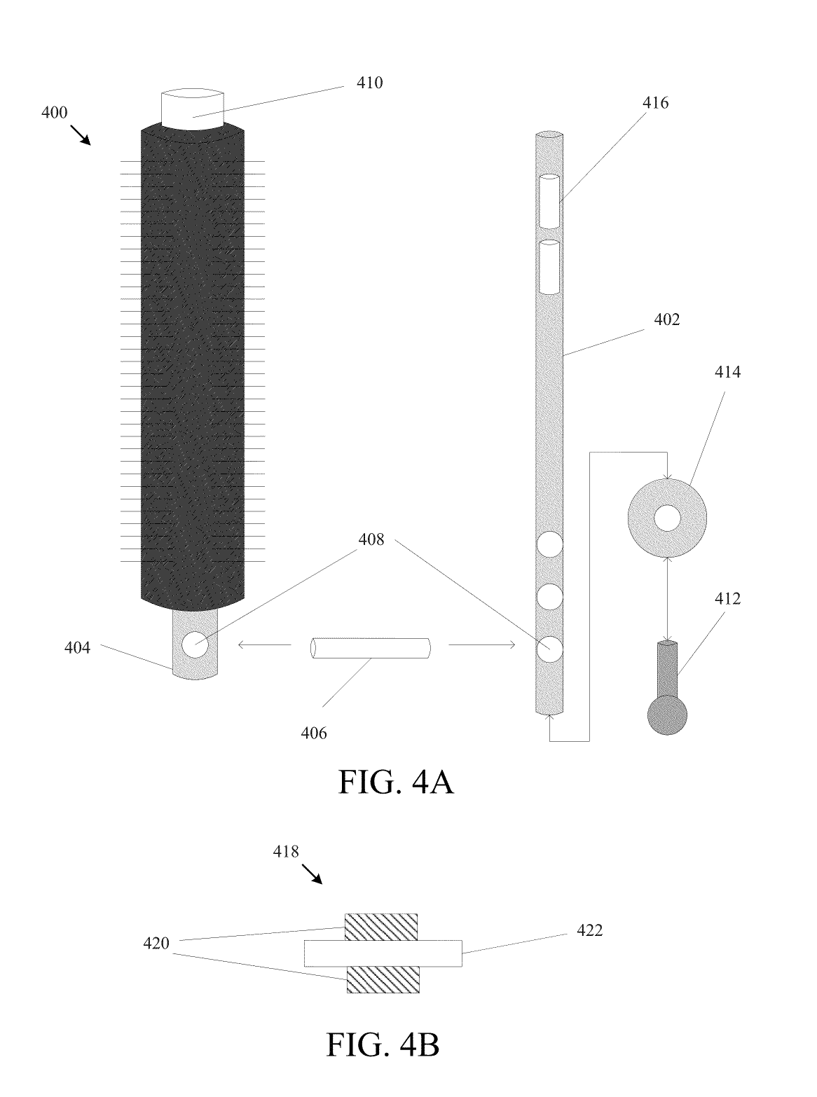

FIG. 4A is a diagram illustrating an expanded view of the brush and corresponding attachments according to one embodiment of the disclosure. In system 400, support post 402 and brush core 404 are shown. In the embodiment shown, all or part of support post 402 and brush core 404 are hollow. In some embodiments, support post 402 and/or brush core 404 may be non-hollow. In some embodiments, support post 402 and/or brush core 404 may be comprised of conductive material. In the embodiment shown, brush core 404 slides over the top of support post 402. Fastener 406 may then be disposed through holes 408 to attach brush core 404 to support post 402. In the embodiment shown, support post 402 contains multiple holes 408 disposed at varying vertical intervals. Fastener 406 may be inserted through any of these holes 408 so brush core 404 may be adjusted to a desired vertical level. In some embodiments, brush core 406 may have one or more caps 410 disposed on one or both of the vertical ends of brush core 406. In some embodiments, caps 410 may comprise vinyl, PVC, plastic or other insulating material. Caps 410 may increase the safety of the device by covering hard edges and insulating a user from excess static charge. In some embodiments, screw or bolt 412 may be inserted through washer 414 into the bottom of support post 402. Screw or bolt 412 and washer 414 may secure support post 402 within grooves to a base, similar to base 302 and grooves 304 shown in FIG. 3.

In some embodiments, a power supply 416 may be attached to support post 402. In the embodiment shown, power supply 416 may comprise one or more batteries inserted into a hollow cavity within support post 402. Power supply 416 may be connected to electrodes coupled to an electrostatic element. that may supply an electric charge to support post 402. The electrode may be disposed within support post 402. In some embodiments, an electrode may be disposed on a bottom of cap 410 so as to make contact with a terminal of power supply 416. The charge may transfer from support post 402 to brush core 404. FIG. 4B is a diagram illustrating an exemplary electrostatic element 418 according to one embodiment of the disclosure. In some embodiments, electrostatic element 418 may comprise one or more capacitors. In the embodiment shown, electrostatic element 418 is comprised of two conductive plates 420 and a dielectric layer 422 sandwiched within. Conductive plates 420 may be comprised of a suitable conductive material. Dielectric layer 422 may be comprised of an insulating material suitable to prevent charge from jumping between conductive plates 420. Electrostatic element 418 may impart a charge to support post 402 and brush core 404. The charge imparted by electrostatic element 418 may create additional charge to that naturally created by the pet's rubbing on the brushes to increase hair collection effectiveness. Power supply 416 may comprise a DC power supply or an AC power supply that may be suitably converted as known in the art.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A pet hair collection apparatus, the apparatus comprising:
a base; and
one or more brushing elements coupled to the base, the brushing elements comprising a material that collects a negative electrostatic charge, wherein one or more pet hairs are collected on the one or more brushing elements based on the negative electrostatic charge.

2. The apparatus of claim 1, further comprising one or more support posts coupled to the base, wherein the one or more brushing elements are coupled to the support posts.

3. The apparatus of claim 1, further comprising one or more arms fastened to the one or more brushing elements.

4. The apparatus of claim 3, wherein the one or more arms connect one brushing element to another brushing element.

5. The apparatus of claim 3, wherein the one or more arms are connected to a single brushing element and disposed to rotate around an axis of the brushing element.

6. The apparatus of claim 1, further comprising one or more pet attraction elements.

7. The apparatus of claim 6, wherein the one or more pet attraction elements are attached to the one or more arms.

8. The apparatus of claim 3, wherein the one or more pet attraction elements are disposed at the base.

9. The apparatus of claim 1, further comprising:
an electrostatic element comprising:
a plurality of conductive plates; and
a dielectric layer disposed between the plurality of conductive plates.

10. The apparatus of claim 9, wherein the electrostatic element is coupled to the one or more brushing elements and provides an electrostatic charge to the one or more brushing elements.

11. A method of removing pet hair, comprising:
creating a negative electrostatic charge on one or more stationary brushing elements;
creating a positive electrostatic charge on one or more pet hairs; and
collecting the one or more pet hairs on the one or more brushing elements.

12. The method of claim 11, wherein the negative electrostatic charge and the positive electrostatic charge are created via friction between the one or more brushing elements and the one or more pet hairs.

13. The method of claim 11, wherein the negative electrostatic charge and the positive electrostatic charge are created via an electrostatic device coupled to the one or more brushing elements.
